(19) United States
(12) Patent Application Publication
(10) Pub. No.: US 2018/0170699 A1
(43) Pub. Date: Jun. 21, 2018

(54) INKJET RECORDING APPARATUS

(71) Applicant: KYOCERA Document Solutions Inc., Osaka (JP)

(72) Inventor: Shinichi Yamasaki, Osaka (JP)

(73) Assignee: KYOCERA Document Solutions Inc., Osaka (JP)

(21) Appl. No.: 15/832,307

(22) Filed: Dec. 5, 2017

(30) Foreign Application Priority Data
Dec. 15, 2016 (JP) 2016-243468

(51) Int. Cl. B65H 7/10; B65H 7/14; B65H 7/20; B65H 9/00; G03G 15/00

(52) U.S. Cl. CPC B65H 7/10; B65H 7/14; B65H 7/20; B65H 9/002; G03G 15/50; B65H 2404/1424; G03G 2215/00721; B65H 2511/242; B65H 2551/27; B65H 2553/414; B65H 2553/822; B65H 2701/1315; B65H 2801/06; B65H 2511/10

(57) ABSTRACT

An inkjet recording apparatus includes a conveyance unit which conveys a recording medium, a recording unit which is disposed opposite the conveyance unit and ejects ink onto a recording medium conveyed by the conveyance unit, an edge position detection sensor which detects edge positions on both sides of the recording medium in a recording-medium width direction, and a control unit which controls ink ejection performed by the recording unit. The recording unit has a recording head where a large number of ink ejection nozzles are arrayed along the recording-medium width direction. The control unit calculates a center position of the recording medium from the edge positions on both sides in the recording-medium width detected by the edge position detection sensor, and shifts a use range of the ink ejection nozzles based on a distance between the center position calculated and a reference center position.

### INCORPORATION BY REFERENCE

This application is based upon and claims the benefit of priority from the corresponding Japanese Patent Application No. 2016-243468 filed on Dec. 15, 2016, the entire contents of which are incorporated herein by reference.

### BACKGROUND

The present disclosure relates to recording apparatuses such as facsimile machines, copiers, and printers, and in particular relates to line-head inkjet recording apparatuses which performs recording by ejecting ink from a plurality of ink ejection nozzles provided in a recording head.

Recording apparatuses such as facsimile machines, copiers, and printers are configured to record images on recording media such as sheets of paper, sheets of cloth, and OHP sheets, and can be classified, according to the recording method used therein, into different types such as an inkjet type, a wire-dot type, and a thermal type. Further, inkjet recording methods can be classified into a serial type, in which recording is performed while a recording head scans across a recording medium, and a line-head type, in which recording is performed by a recording head fixed to a body of the recording apparatus.

When printing on recording media using a recording apparatus, the recording media positionally deviate from each other in a direction (a recording medium width direction) which is perpendicular to a sheet conveyance direction, printing positions on the individual recording media will also positionally deviate from each other. In a case where the recording media are to be bound together after printing, the printing positions on the individual recording media are required to coincide with each other with high accuracy. In particular, with an inkjet recording apparatus, since ink is likely to soak into and bleed through a recording medium, in a case of double printing, printing positions on the individual recording media are required to coincide with each other with higher accuracy (for example, with allowable deviation of zero point several millimeters or less).

To achieve such accuracy, a conventional image forming apparatus includes a contact image sensor (CIS) which detects a position of an edge of a sheet in a width direction of the sheet, and which is disposed on a sheet conveyance belt which conveys sheets (recording media). In such an image forming apparatus, the position of an edge of the sheet in its width direction is detected based on variation in intensity of light that the CIS receives caused by presence/absence of the sheet.

For example, there is known an edge detection device that binarizes values outputted from a CIS disposed in a conveyance path through which conveyed objects (sheets) are conveyed, and which, when a position at which the resulting binary values change from one to another is present within one of edge-detection ranges stored one individual different sizes of conveyed objects, determines that the position is an edge position of the conveyed object. Further, it is also a know technique to shift a conveyed object in its width direction based on an amount of deviation (deviation amount) of the detected edge position from a reference position.

### SUMMARY

According to one aspect of the present disclosure, an inkjet recording apparatus includes a conveyance unit, a recording unit, an edge position detection sensor, and a control unit. The conveyance unit conveys a recording medium. The recording unit is disposed opposite the conveyance unit and ejects ink onto the recording medium conveyed by the conveyance unit. The edge position detection sensor is disposed on an upstream side of the conveyance unit with respect to a recording-medium conveyance direction in which the recording medium is conveyed, and detects edge positions on both sides of the recording medium in a recording-medium width direction which is perpendicular to the recording-medium conveyance direction. The control unit controls ink ejection performed by the recording unit. The recording unit has a recording head where a large number of ink ejection nozzles are arrayed along the recording-medium width direction. The control unit calculates a center position of the recording medium from the edge positions on both sides of the recording medium in the recording-medium width direction, the edge positions having been detected by the edge position detection sensor, and shifts a use range of the ink ejection nozzles based on a distance between the center position calculated and a reference center position.

Further features and specific advantages of the present disclosure will become apparent from the following descriptions of preferred embodiments.

### BRIEF DESCRIPTION OF THE DRAWINGS

FIG. 1 is a side sectional view showing an outline of a configuration of a printer according to an embodiment of the present disclosure;

FIG. 2 is a side sectional view showing a structure around a first belt conveyance unit, a recording unit, and a second belt conveyance unit of the printer of the present embodiment;

FIG. 3 is a plan view of the first belt conveyance unit and the recording unit of the printer of the present embodiment as seen from above;

FIG. 4 is a side view around a CIS and an LED of the printer of the present embodiment;

FIG. 5 is a plan view showing a structure around the CIS and the first belt conveyance unit of the printer of the present embodiment;

FIG. 6 is a block diagram showing a control path of ink-ejection-position correction control in the printer of the present embodiment;

FIG. 7 is a plan view showing the structure around the CIS and the first belt conveyance unit of the printer of the present embodiment, with a sheet deviated toward an apparatus front side;

FIG. 8 is a diagram showing shifting of ink ejection positions in the printer of the present embodiment, in a case where a sheet has deviated toward the apparatus front side;

FIG. 9 is a plan view showing the structure around the CIS and the first belt conveyance unit of the printer of the present embodiment, with a sheet deviated such that part thereof exists in an area outside an effective detection area of the CIS;

FIG. 10 is a diagram showing ink ejection positions in the printer of the present embodiment, in a case where a sheet has deviated toward the apparatus front side by a predetermined threshold value or more; and

FIG. 11 is a flow chart showing an example of control performed when printing is performed in the printer of the present embodiment.

### DETAILED DESCRIPTION

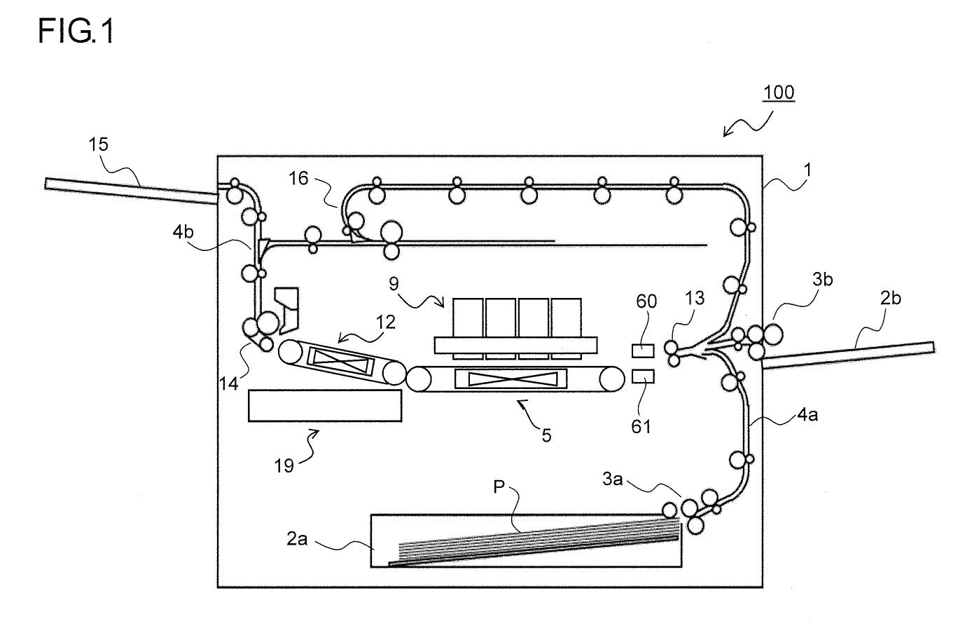

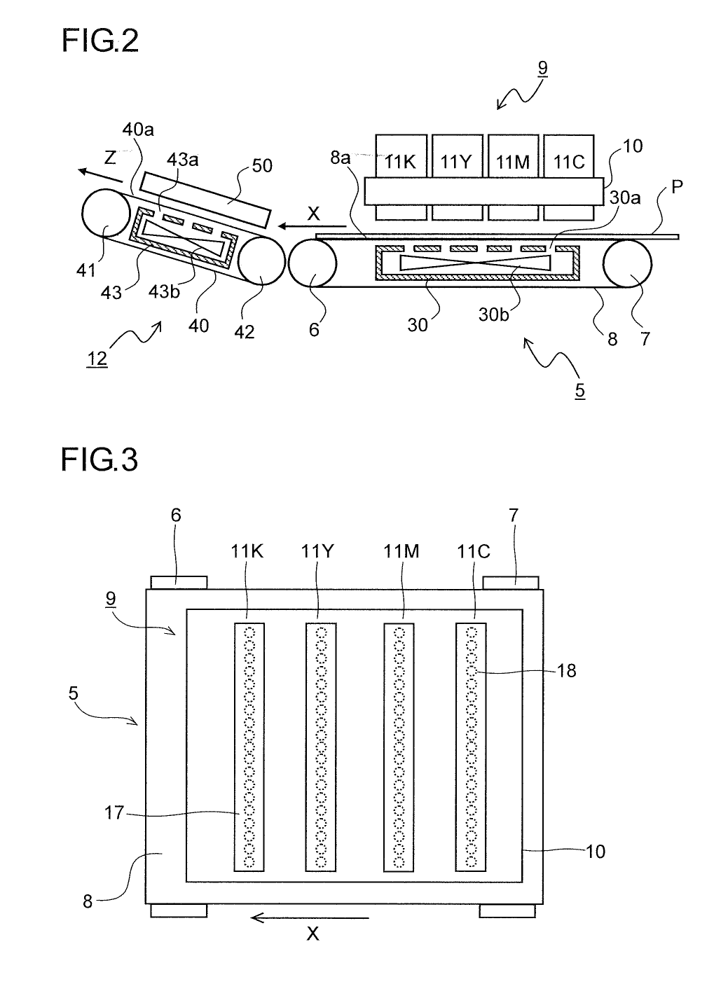

Hereinafter, descriptions will be given of embodiments of the present disclosure with reference to the accompanying drawings. FIG. 1 is a diagram showing an outline of a configuration of a printer 100 according to an embodiment of the present disclosure employing an inkjet printing method, FIG. 2 is a sectional view showing a structure around a first belt conveyance unit 5, a recording unit 9, and a second belt conveyance unit 12 of the printer 100 shown in FIG. 1, and FIG. 3 is a plan view of the first belt conveyance unit 5 and the recording unit 9 of the printer 100 shown in FIG. 1, as seen from above.

As shown in a FIG. 1, in the printer 100, in a lower portion inside a printer main body 1, a sheet feed cassette 2a is arranged as a sheet container unit, and on an external right side surface of the printer main body 1, there is provided a manual sheet feed tray 2b. On a downstream side of the sheet feed cassette 2a with respect to a sheet conveyance direction, that is, on an upper right side of the sheet feed cassette 2a in FIG. 1, there is provided a sheet feed device 3a. Further, on a downstream side of the manual sheet feed tray 2b with respect to the sheet conveyance direction, that is, on a left side of the manual sheet feed tray 2b in FIG. 1, there is provided a sheet feed device 3b. By these sheet feed devices 3a and 3b, sheets P are separated from each other to be fed out one by one.

The printer 100 is further provided therein with a first sheet conveyance passage 4a. The first sheet conveyance passage 4a is disposed to the upper right of the sheet feed cassette 2a, and to the left of the manual sheet feed tray 2b. A sheet P coming in from the sheet feed cassette 2a is conveyed through the first sheet conveyance passage 4a vertically upward along a side surface of the printer main body 1. On the other hand, a sheet P coming in from the manual sheet feed tray 2b is conveyed through the first sheet conveyance passage 4a leftward in a substantially horizontal direction.

At a downstream end of the first sheet conveyance passage 4a with respect to the sheet conveyance direction, a registration roller pair 13 is provided. Further, on the downstream side of the registration roller pair 13, immediately close to the registration roller pair 13, the first belt conveyance unit 5 and the recording unit 9 are disposed. The registration roller pair 13 corrects oblique feeding of a sheet P, and feeds out the sheet P toward the first belt conveyance unit 5 with timing coordinated with an ink ejection operation performed by the recording unit 9.

Further, between the registration roller pair 13 and the first belt conveyance unit 5, there are disposed a CIS 60 and an LED 61 for detecting positions of edges of the sheet P in its width direction (a direction perpendicular to the sheet conveyance direction). Configurations around the CIS 60 and the LED 61 will be described later in detail.

The first belt conveyance unit 5 includes a first conveyance belt 8 (see FIG. 2), which is an endless belt wound around a first drive roller 6 and a first driven roller 7. The sheet P fed out of the registration roller pair 13 is adsorbed and held on a surface of the first conveyance belt 8 to pass under the recording unit 9.

Inside the first conveyance belt 8, at a portion facing a back side of a conveyance surface 8a of the first conveyance belt 8, there is provided a first sheet suction unit 30. The first sheet suction unit 30 includes a large number of holes 30a formed in a top surface thereof for sucking air therethrough, and internally includes a fan 30b, so that air can be sucked downward through the top surface. The first conveyance belt 8 includes a large number of vent holes 8b (see FIG. 5) for air to be sucked therethrough. With this configuration, the first belt conveyance unit 5 conveys the sheet P while adsorbing and holding the sheet P on the conveyance surface 8a of the first conveyance belt 8.

The recording unit 9 includes line heads 11C, 11M, 11Y, and 11K, which perform recording of an image on the sheet P conveyed while being adsorbed and held on the conveyance surface 8a of the first conveyance belt 8. In accordance with information brought by image data received from an external computer or the like, inks in the line heads 110 to 11K are sequentially ejected from the line heads 110 to 11K toward the sheet P adsorbed on the first conveyance belt 8. Thereby, a full-color image, in which the four yellow, magenta, cyan, and black colors are superimposed on each other, is recorded on the sheet P. Note that the printer 100 is also capable of recording a monochrome image.

As shown in FIG. 3, the recording unit 9 is provided with a head housing 10 and the line heads 110, 11M, 11Y, and 11K supported in the head housing 10. These line heads 11C to 11K each have a recording area which is as wide as or wider than the width of the sheet P conveyed thereto. The line heads 110 to 11K are supported at a height such that a predetermined gap (for example, 1 mm) is formed between the line heads 11C to 11K and the conveyance surface 8a of the first conveyance belt 8. Recording heads 17 are provided in the line heads 110 to 11K to extend along the sheet width direction (the up-down direction in FIG. 3), which is perpendicular to the sheet conveyance direction. The recording heads 17 each have an ink ejection surface, where a large number of ink ejection nozzles 18 are arrayed.

To the recording heads 17 respectively constituting the line heads 110 to 11K, four color (cyan, magenta, yellow, and black) inks each stored in an ink tank (not shown) are supplied corresponding to the colors of the line heads 110 to 11K.

In accordance with the image data received from an external computer or the like, each of the recording heads 17 ejects ink from such ones of the ink ejection nozzles 18 as correspond to printing positions toward the sheet P conveyed while being adsorbed and held on the conveyance surface 8a of the first conveyance belt 8. Thereby, a color image, where inks of four colors of cyan, magenta, yellow, and black are superimposed on each other, is formed on the sheet P held on the first conveyance belt 8.

On a downstream side of the first belt conveyance unit 5 with respect to the sheet conveyance direction (the left side in FIG. 1), the second belt conveyance unit 12 is disposed. The sheet P on which an image has been recorded at the recording unit 9 is sent to the second belt conveyance unit 12, and the ink which has been ejected onto a surface of the sheet P is dried while the sheet P passes along the second belt conveyance unit 12.

The second belt conveyance unit 12 includes a second conveyance belt 40 which is an endless belt wound around a second drive roller 41 and a second driven roller 42. The second conveyance belt 40 is caused by the second drive roller 41 to rotate in the counterclockwise direction in FIG. 2. The sheet P, having an image recorded thereon by the recording unit 9 and conveyed by the first belt conveyance unit 5 in an arrow-X direction, is then received on the second conveyance belt 40, which conveys the sheet P in an arrow-Z direction in FIG. 2.

Inside the second conveyance belt 40, at a portion facing a back side of a conveyance surface 40a of the second conveyance belt 40, there is provided a second sheet suction unit 43. The second sheet suction unit 43 includes a large number of holes 43a formed in a top surface thereof for sucking air therethrough, and internally includes a fan 43b, so that air can be sucked downward through the top surface. The second conveyance belt 40 also includes a large number of vent holes (not shown) for air to be sucked therethrough. With this configuration, the second belt conveyance unit 12 conveys the sheet P while adsorbing and holding the sheet P on the conveyance surface 40a of the second conveyance belt 40.

At a position opposite from the conveyance surface 40a of the second conveyance belt 40, there is provided a conveyance guide unit 50. The conveyance guide unit 50 constitutes a sheet conveyance path together with the conveyance surface 40a of the second conveyance belt 40, and helps reduce warping and fluttering of the sheet P caused to be adsorbed and held on the conveyance surface 40a by the second sheet suction unit 43.

At a position on a downstream side of the second belt conveyance unit 12 with respect to the sheet conveyance direction, close to a left side surface of the printer main body 1, there is provided a decurler unit 14. The sheet P, having had the ink thereon dried at the second belt conveyance unit 12, is sent to the decurler unit 14, where curling caused in the sheet P is straightened.

On a downstream side of the decurler unit 14 with respect to the sheet conveyance direction (in an upper portion of FIG. 1), there is provided a second sheet conveyance passage 4b. In a case where double-sided recording is not to be performed, after passing through the decurler unit 14, the sheet P is conveyed through the second sheet conveyance passage 4b, via a discharge roller pair, onto a sheet discharge tray 15, which is provided on an external left side surface of the printer 100. In a case where double-sided recording is to be performed, the sheet P on one side of which recording has been completed passes on the second belt conveyance unit 12 and through the decurler unit 14, to be conveyed through the second sheet conveyance passage 4b into a reverse conveyance passage 16. In the reverse conveyance passage 16, the sheet conveyance direction is switched to turn the sheet P upside down, and then the sheet P passes through an upper portion of the printer 100 to be conveyed to the registration roller pair 13. Then, the sheet P is again conveyed, with a non-image-recorded side thereof up, onto the first belt conveyance unit 5.

Under the second belt conveyance unit 12, a maintenance unit 19 is disposed. For maintenance of the recording heads 17, the maintenance unit 19 moves to under the recording unit 9 to remove the ink ejected (purged) from the ink ejection nozzles 18 (see FIG. 3) of the recording heads 17, and collects the removed ink.

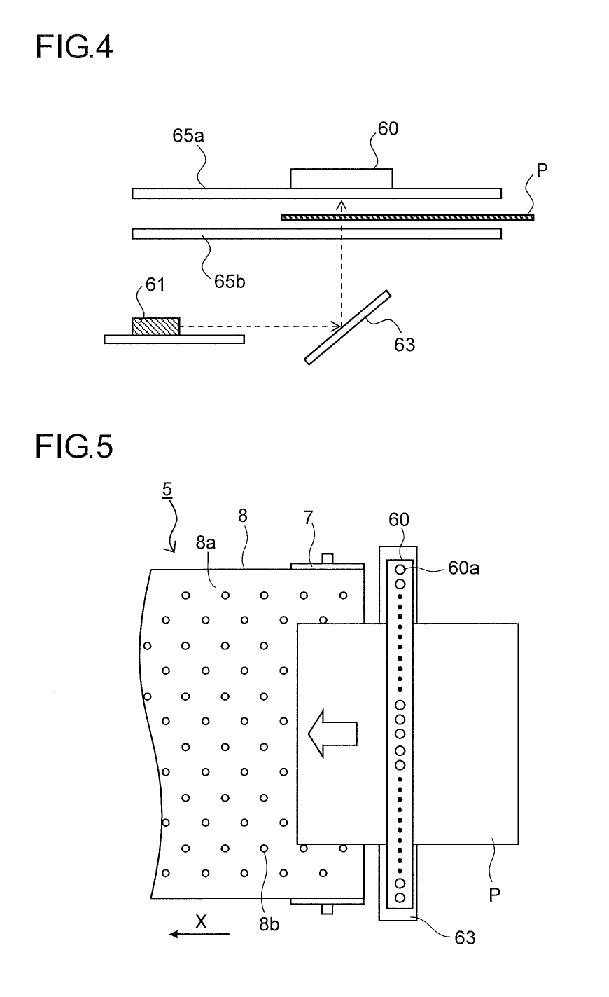

Next, a description will be given of the details of the configuration around the CIS 60 and the LED 61. FIG. 4 is a side view around the CIS 60 and the LED 61 of the printer 100 of the present embodiment. FIG. 5 is a plan view showing a structure around the CIS 60 and the first belt conveyance unit 5 of the printer 100 of the present embodiment. The CIS 60 is disposed on an upstream side of the first belt conveyance unit 5 with respect to the sheet conveyance direction, and the LED 61 is disposed below the CIS 60. Directly under the CIS 60, a white panel 63 is disposed which reflects laser light emitted from the LED 61 to direct the reflected laser light to the CIS 60.

As shown in FIG. 4, directly under the CIS 60, two contact glasses 65a and 65b are disposed to face each other. A lower surface of the contact glass 65a and an upper surface of the contact glass 65b form part of the sheet conveyance path.

As shown in FIG. 5, the CIS 60 includes a large number of detection units 60a, which are photoelectric conversion elements and arrayed along the sheet width direction (the up-down direction in FIG. 5). The CIS 60 detects the position of an edge of the sheet P in its width direction based on an intensity difference between such ones of the detection units 60a as have reflection light from the white panel 63 directly incident thereon and such ones of the detection units 60a as have such part of reflection light from the white panel 63 as has passed through the sheet P incident thereon.

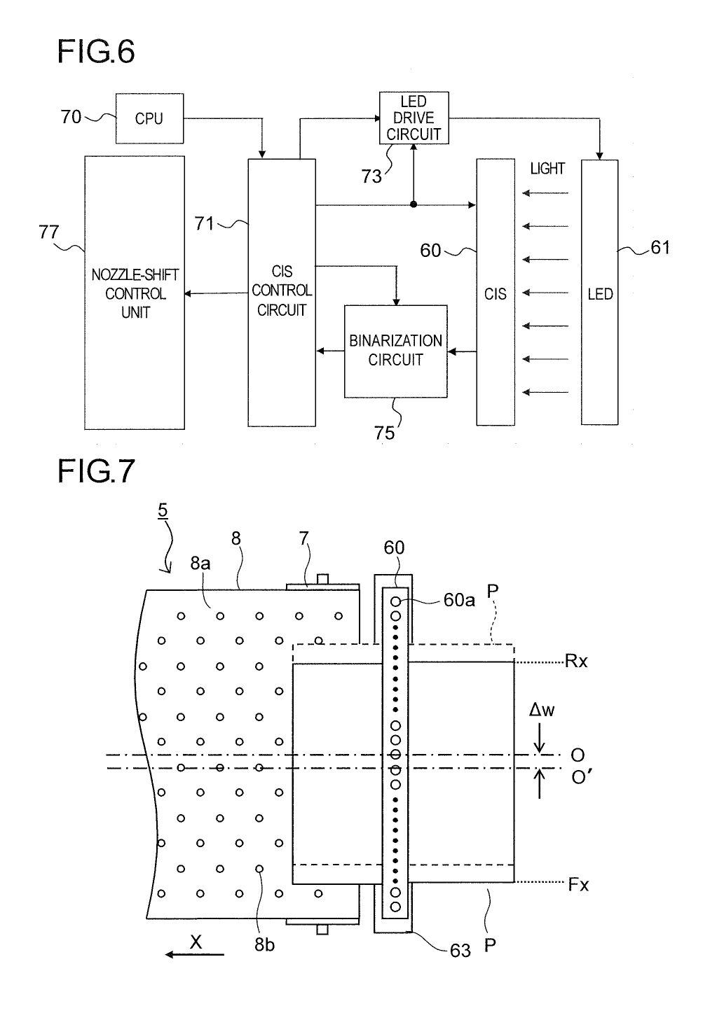

FIG. 6 is a block diagram showing a control path of ink-ejection-position correction control in the printer 100 of the present embodiment. The overall ink-ejection-position correction is integrally controlled by a CPU 70. Here, the CPU 70 may simultaneously perform another control related to the printer 100 as a main CPU of the printer 100. In other words, the ink-ejection-position correction control may be implemented as one of functions of the main CPU of the printer 100. When a printing operation by the printer 100 onto a sheet P is started, the CPU 70 makes various settings for reading signals from the CIS 60 with respect to a CIS control circuit 71.

The CIS control circuit 71, in accordance with the settings made by the CPU 70, transmits the following to the CIS 60: a reference clock signal for reading a signal from the CIS 60; and a storage time determination signal for determining a charge storage time. The CIS control circuit 71 transmits a PWM signal to an LED drive circuit 73 to set a value of current to flow through the LED 61. The LED drive circuit 73 generates a direct-current voltage in accordance with the PWM signal received from the CIS control circuit 71, and uses the direct-current voltage as a reference voltage of the current to flow through the LED 61. The CIS control circuit 71 generates a comparison reference voltage (a threshold voltage) for binarizing an analog signal (an output signal) from the CIS 60 by means of a binarization circuit 75.

When timing comes for the sheet P in a standby state at the registration roller pair 13 (see FIG. 1) to be conveyed toward the recording unit 9, the CPU 70 instructs the CIS control circuit 71 to start edge detection. On receiving the instruction to start the edge detection from the CPU 70, the CIS control circuit 71, in synchronization with the storage time determination signal, transmits, to the LED drive circuit 73, a control signal to turn on the LED 61. The LED drive circuit 73, in accordance with the control signal from the CIS control circuit 71, turns on the LED 61 and keeps it on for a certain period of time.

While the LED 61 is kept on, the CIS 60 outputs a voltage corresponding to an amount of light stored in each pixel (photoelectric conversion element) of pixel groups of the detection units 60a as an output signal from each pixel, based on a next storage time determination signal and the reference clock signal. Output signals from the CIS 60 are each binarized by the binarization circuit 75 through comparison with the comparison reference voltage (the threshold voltage), and fed to the CIS control circuit 71 as digital signals.

With respect to each of the output signals from the CIS 60, the CIS control circuit 71 sequentially checks, on a pixel-by-pixel basis, the values of 0/1 of the digital signals binarized by the binarization circuit 75. Then, the CIS control circuit 71 detects the position of a pixel of the detection units 60a (the position of a photoelectric conversion element) at which values of the digital signals switch from 0 to 1, or from 1 to 0.

On detecting the position of the pixel at which the values of the digital signals switch, the CIS control circuit 71 judges the position of the pixel to be an edge position of the sheet P in its width direction. The CPU 70 calculates an amount of deviation (deviation amount) of the edge position determined by the CIS control circuit 71 from an edge position (a reference edge position) of the sheet P taken when the sheet P is conveyed in an ideal conveyance position (a reference conveyance position), passing along a center position of a sheet-passing area. The obtained deviation amount is transmitted to a nozzle shift control unit 77. The nozzle shift control unit 77 shifts a range of the ink ejection nozzles 18 to be used in the recording unit 9, in accordance with the received deviation amount of the sheet P in its width direction.

FIG. 7 is a plan view showing the structure around the CIS 60 and the first belt conveyance unit 5 of the printer 100 of the present embodiment, with a sheet P deviated toward an apparatus front side (downward in FIG. 7). In FIG. 7, let the reference conveyance position be a conveyance position taken in a case (indicated by broken lines in FIG. 7) where the center of the sheet P in its width direction passes along a reference center position O of the sheet-passing area.

When the sheet P has deviated a predetermined amount from the reference conveyance position toward the front side of the apparatus (indicated by solid lines in FIG. 7), edge positions of the sheet P on the apparatus rear and front sides (upper and lower sides in FIG. 7) also shifts to Rx and Fx, respectively. Rx and Fx are determined by detecting, by means of the CIS control circuit 71, positions of pixels at which the digital signals obtained by the binarization circuit 75 binalizing the output signals (analog signals) from the CIS 60 switch. Then, the CPU 70 calculates the actual center position O′ of the sheet P conveyed, and, from the distance between the actual center position O′ and the reference center position O, the CPU 70 calculates the amount of deviation (=Δw) of the sheet P in its width direction.

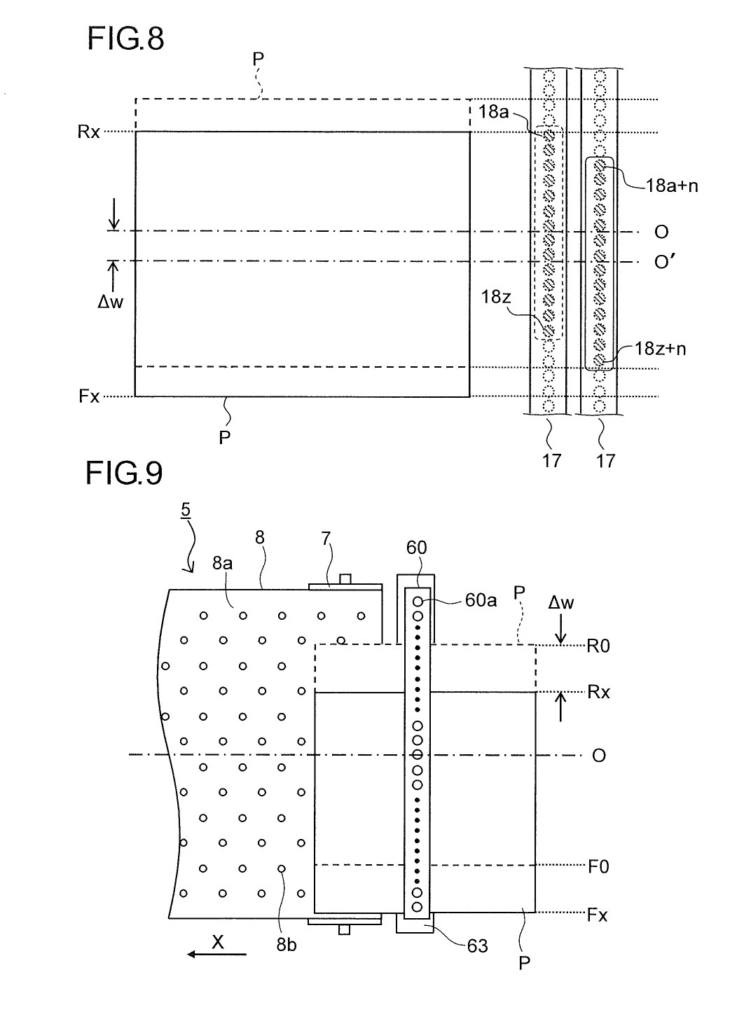

FIG. 8 is a diagram for illustrating shifting of ink ejection positions in a case where the sheet P has deviated toward the apparatus front side. In a case where the sheet P is conveyed in the reference conveyance position (the position indicated by broken lines in FIG. 8), each recording head 17 uses the a-th ink ejection nozzle 18a to the z-th ink ejection nozzle 18z of the ink ejection nozzles 18 to record an image on the sheet P.

If the ink ejection nozzles 18a to 18z were used to record an image on the sheet P in the case where the sheet P is conveyed in a position (indicated by solid lines in FIG. 8) deviated frontward from the reference conveyance position, the image would be recorded at a position deviated rearward from the position at which it should be recorded.

To prevent this, a shift amount for the ink ejection nozzles 18 is determined corresponding to the deviation amount Δw of the sheet P in its width direction, and ink ejection nozzles 18 to be used are shifted in each recording head 17. In the example of FIG. 8, the deviation amount Δw is equivalent to a distance corresponding to an n-number of nozzles, and hence, an ink ejection nozzle 18a+n to an ink ejection nozzle 18z+n are going to be used, the ink ejection nozzle 18a+n being disposed at a position deviating frontward from the ink ejection nozzle 18a by the distance corresponding to the n-number of nozzles, the ink ejection nozzle 18z+n being disposed at a position deviating frontward from the ink ejection nozzle 18z by the distance corresponding to the n-number of nozzles.

As a result, printing can be performed on the center of the sheet P in its width direction, without moving the sheet P in its width direction. This eliminates the need of a mechanism, such as a shift roller, to shift the position of the sheet P in its width direction, and thus helps simplify the configuration and the control of the printer 100.

Furthermore, as described above, the edge positions on both sides of the sheet P in its width direction are detected, and the deviation amount of the sheet P in its width direction is calculated from the distance between the actual center position O′ calculated from the detected edge positions and the reference center position O, and this makes it possible to calculate the deviation amount in the width direction of the sheet P without using information of the size of the sheet P.

Here, it is also possible to dispose two CISs 60 one on each edge side in the width direction of the sheet P to separately detect the edge positions of the sheet P on both sides in its width direction, but in such an arrangement, for accurate detection of the edge positions, it is necessary to exactly regulate the distance between the two CISs 60. However, in the present embodiment, since one CIS 60 in which a plurality of detection units 60a are continuously arrayed over a distance from one edge to the other edge of the sheet P in its width direction is used to determine the edge positions of the sheet P, there is no risk of degradation of detection accuracy resulting from a mounting error in installing the CIS 60.

FIG. 9 is a diagram showing a case where the edge position of one side (the apparatus front side, the lower side in FIG. 9) of the sheet P in its width direction has deviated into an area outside an effective detection area of the CIS 60. In the state shown in FIG. 9, it is impossible to detect the edge position Fx on the apparatus front side of the sheet P, and thus it is impossible to calculate the actual center position O′. In this case, the deviation amount Δw of the sheet P in its width direction is calculated based on a distance between the edge position Rx on the apparatus rear side of the sheet P and a reference edge position RO, which is the edge position on the apparatus rear side of the sheet P taken when the sheet P is conveyed in the reference conveyance position, and the ink ejection nozzles 18 to be used in the recording head 17 are shifted.

Thereby, even in a case where one of the edge positions of the sheet P in its width direction has deviated into an area outside the effective detection area of the CIS 60, it is possible to calculate the deviation amount Δw of the sheet P in its width direction from a distance between the other edge position and a reference edge position for the other edge position. Here, the reference edge position RO is different for different sheet-P sizes, and thus, in the case where the deviation amount Δw of the sheet P in its width direction is calculated from a distance between one of the edge positions of the sheet P and a reference edge position for the one of the edge positions, information of the size of the sheet P needs to be provided. The information of the size of the sheet P is transmitted to the CPU 70 from an unillustrated sheet-size detection sensor disposed on the sheet feed cassette 2a, an unillustrated sheet-size detection sensor disposed on the manual sheet feed tray 2b, or an external device such as a personal computer.

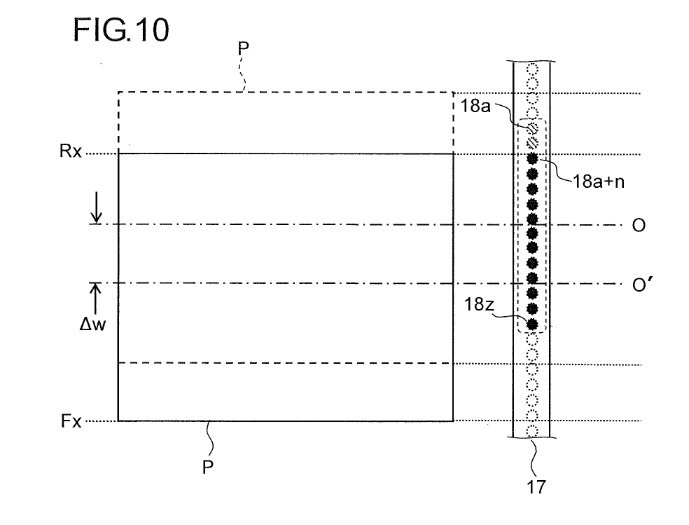

FIG. 10 is a diagram showing ink ejection positions in a case where the sheet P has deviated toward the apparatus front side by a predetermined threshold value or more. With a large deviation amount Δw of the sheet P, which implies that a conveyance failure has occurred, it is impossible to record an image in the center of the sheet P in its width direction even by shifting the ink ejection nozzles 18 to be used. In addition, there is a risk that ink will be ejected to a position outside the sheet P in its width direction to stain the first conveyance belt 8. To prevent this, when the deviation amount Δw is equal to or more than the predetermined threshold value, without shifting the ink ejection nozzles 18 to be used, ink is ejected only from such ones of the ink ejection nozzles 18 as are located facing the sheet P (here, the ink ejection nozzles 18a+n to 18z).

This makes it possible to prevent the first conveyance belt 8 from being stained with ink ejected to an area outside the sheet P in its width direction. Here, the image recorded on the sheet P, which is a chipped image, may be discharged onto a waste sheet tray (not shown) which is different from the normally used sheet discharge tray 15.

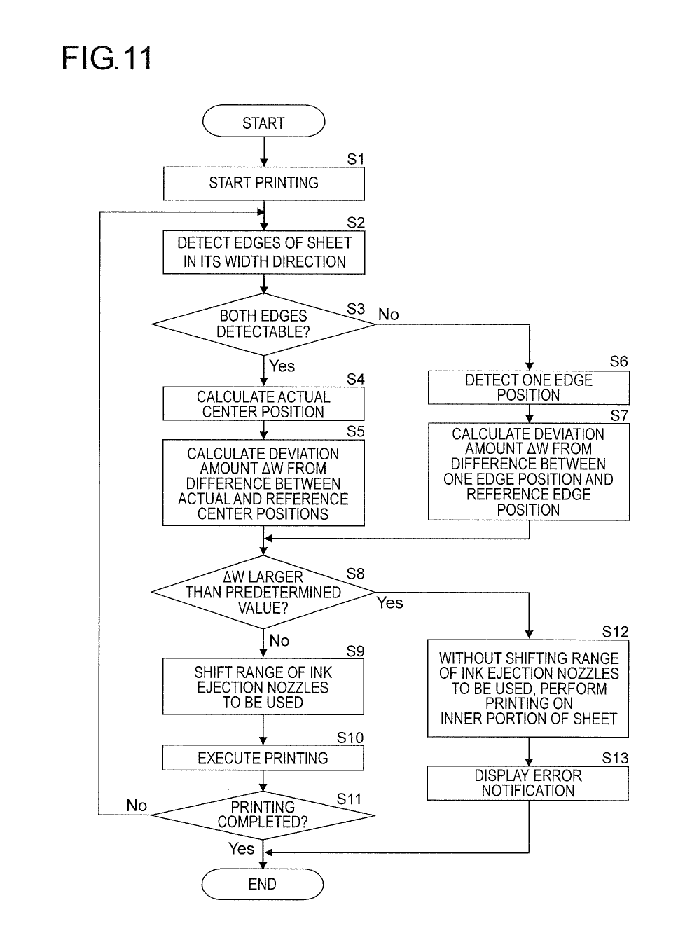

FIG. 11 is a flow chart showing an example of control for printing executed in the printer 100 of the present embodiment. Referring to FIG. 1 to FIG. 10 as necessary, a description will be given of the procedure of printing performed by the printer 100, along the steps illustrated in FIG. 11.

When printing is started in response to receipt of a printing instruction from a host apparatus such as a personal computer (step S1), a sheet P is fed from the sheet feed cassette 2a or the manual sheet feed tray 2b, and the CIS 60 detects edges of the sheet P in its width direction (step S2).

Next, a judgment is made on whether or not both of the edges of the sheet P in its width direction are detectable (step S3). When both of the edges of the sheet P in its width direction are found detectable (Yes in step S3), the CPU 70 calculates the actual center position O′ based on information of the detected edge positions on both sides of the sheet P (step S4). Then, the CPU 70 calculates the deviation amount Δw of the sheet P in its width direction from the distance between the actual center position O′ and the reference center position O (step S5).

On the other hand, when only one of the two edges of the sheet P in its width direction is detectable (No in step S3), the detectable edge position is detected (step S6), and the CPU 70 calculates the deviation amount Δw from the distance between the detected edge position and the reference edge position for the detected edge position (step S7).

Next, the CPU 70 judges whether or not the calculated deviation amount Δw is equal to or more than the predetermined threshold value (step S8). When Δw is not above the threshold value (No in step S8), the ink ejection nozzles 18 to be used are shifted in accordance with Δw (step S9), and then printing is executed (step S10). Thereafter, a judgment is made on whether or not the printing is completed (step S11), and when it is found that the printing is still being performed, the procedure returns to step S2, and the detection of the edges of the sheet P in its width direction (step S2) and making of a judgment on the necessity of shifting the ink ejection nozzles 18 to be used are repeated (step S2 to step S10). Then, the processing is finished when the printing is completed.

On the other hand, when Δw is equal to or more than the threshold value (Yes in step S8), the ink ejection nozzles 18 to be used are not shifted, and printing is performed on an inner portion of the sheet P (step S12). Then, an error notification is displayed on a liquid crystal display unit (not shown) in an operation panel or the like (step S13), and the processing is finished.

The embodiments described above are in no way meant to limit the present disclosure, which thus allows for many modifications and variations within the spirit of the present disclosure. For example, although the above-described embodiment has dealt with an example where the CIS 60 is of a transmissive type provided with detection units 60a which receive laser light from the LED 61, it is also possible to use, for example, a reflective CIS which is provided with a light emission unit for emitting light toward a sheet and detects reflection light from the sheet by means of detection units to determine an edge position based on a difference in intensity between reflection light from the sheet and reflection light from areas where the sheet does not pass. In this case, it is preferable to dispose a background member in a color different from the color of the sheet (white) to face the detection surface of the CIS so as to enhance the intensity difference between the reflection light from the sheet and the reflection light from the areas where the sheet does not pass.

Further, although the above-described embodiment has dealt with an example where the CIS 60 is used as a sensor for detecting the positions of edges of the sheet P, a sensor other than a CIS, such as a CCD, may be used instead.

The number of the ink ejection nozzles 18, the nozzle-to-nozzle distance, etc. in the recording heads 17 may be set appropriately in accordance with the specifications of the printer 100. There is no specific limitation to the number of the recording heads 17, and, for example, two or more recording heads 17 may be arranged in each of the line heads 110 to 11K.

What is claimed is:

1. An inkjet recording apparatus comprising:
a conveyance unit which conveys a recording medium;
a recording unit which is disposed opposite the conveyance unit and ejects ink onto the recording medium conveyed by the conveyance unit;
an edge position detection sensor which is disposed on an upstream side of the conveyance unit with respect to a recording-medium conveyance direction in which the recording medium is conveyed, and which detects edge positions on both sides of the recording medium in a recording-medium width direction which is perpendicular to the recording-medium conveyance direction; and
a control unit which controls ink ejection performed by the recording unit,
wherein
the recording unit has a recording head where a large number of ink ejection nozzles are arrayed along the recording-medium width direction,
the control unit calculates a center position of the recording medium from the edge positions on both sides of the recording medium in the recording-medium width direction, the edge positions having been detected by the edge position detection sensor, and the control unit shifts a use range of the ink ejection nozzles based on a distance between the center position calculated and a reference center position.

2. The inkjet recording apparatus according to claim 1,
wherein,
when an edge position on one side of the recording medium in the recording-medium width direction exists outside an effective detection area of the edge position detection sensor, the control unit shifts the use range of the ink ejection nozzles based on a distance between an edge position on an other side of the recording medium in the recording-medium width direction and a reference edge position determined based on information of a size of the recording medium.

3. The inkjet recording apparatus according to claim 2,
wherein
the control unit calculates a number of the ink ejection nozzles that corresponds to the distance between the center position and the reference center position or the distance between the edge position on the other side of the recording medium in the recording-medium width direction and the reference edge position, and the control unit shifts the use range of the ink ejection nozzles in a deviation direction of the recording medium by the number calculated.

4. The inkjet recording apparatus according to claim 2,
wherein
when the distance between the center position and the reference center position or the distance between the edge position on the other side of the recording medium in the recording-medium width direction and the reference edge position is equal to or more than a predetermined threshold value, the control unit does not shift the use range of the ink ejection nozzles, and allows ink to be ejected only from such ones of the ink ejection nozzles as face the recording medium.

5. The inkjet recording apparatus according to claim 1,
wherein
the edge position detection sensor is a contact image sensor having a plurality of photoelectric conversion elements arrayed along the recording-medium width direction, and
the control unit judges a position of a pixel at which values of digital signals obtained by binarizing output signals from the contact image sensor switch to be an edge position of the recording medium in the recording-medium width direction.

6. The inkjet recording apparatus according to claim 5,
wherein
a number of the contact image sensor used, which includes the plurality of photoelectric conversion elements continuously arrayed over the recording-medium width direction from one to the other ends of the recording medium in the recording-medium width direction, is one.

7. The inkjet recording apparatus according to claim 5, further comprising:
a light source unit disposed opposite the contact image sensor with a recording-medium conveyance passage therebetween; and
a reflection panel which reflects light emitted from the light source unit and directs the light toward the contact image sensor.
